(19) United States
(12) Patent Application Publication
(10) Pub. No.: US 2009/0248707 A1
(43) Pub. Date: Oct. 1, 2009

(54) SITE-SPECIFIC INFORMATION-TYPE DETECTION METHODS AND SYSTEMS

(75) Inventors: Rupesh R. Mehta, Maharashtra (IN); Amit Madaan, Uttar Pradesh (IN)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/055,222

(22) Filed: Mar. 25, 2008

(51) Int. Cl. G06F 17/30

(52) U.S. Cl. 707/100; 707/E17.044

(57) ABSTRACT

Methods and systems are provided herein that may allow for pertinent information-type(s) of data to be located or otherwise identified within one or more documents, such as, for example, web page documents associated with one or more websites. For example, exemplary methods and systems are provided that may be used to determine if information may be more likely to be of an “informative” type of information or possibly more likely to be of a “noise” type of information.

### CROSS REFERENCE TO RELATED APPLICATIONS

This application is related to U.S. patent application Ser. No. ______ (Atty. Dkt. 50269-0944 (Y02195US00)) filed on ______, titled “TECHNIQUES FOR INDUCING HIGH QUALITY STRUCTURAL TEMPLATES FOR ELECTRONIC DOCUMENTS”, the entire content of which is incorporated by reference for all purposes as if fully disclosed herein.

### BACKGROUND

1. Field

The subject matter disclosed herein relates to data processing, and more particularly to information extraction and information retrieval methods and systems.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available, there is a continuing need for methods and systems that allow for pertinent information to be located or otherwise identified in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1. is a block diagram illustrating an exemplary computing environment including an information integration system in accordance with certain aspects of the present description.

FIG. 2 is a flow diagram illustrating an exemplary method that may, for example, be implemented at least in part using the information integration system of FIG. 1.

FIG. 3 is a flow diagram illustrating an exemplary method that may, for example, be implemented at least in part using the information integration system of FIG. 1.

FIG. 4 is an illustrative diagram showing portions of a rendered web page that may be associated with the information integration system of FIG. 1.

FIG. 5A is an illustrative diagram showing an exemplary document that may be associated with the web page of FIG. 4.

FIG. 5B is an illustrative diagram showing an exemplary DOM structure that may be associated with the document of FIG. 5A.

FIG. 6 is a block diagram illustrating an exemplary embodiment of a computing environment system that may be operatively associated with computing environment of FIG. 1.

### DETAILED DESCRIPTION

Methods and systems are provided herein that may allow for pertinent or different types of information (information-types) to be located or otherwise identified within one or more documents. For example, exemplary methods and systems are described that may be used to determine or otherwise assist in determining if information may be more likely to be of an “informative” type of information or possibly more likely to be of a “noise” type of information, as may be determined based on various factors. Here, “informative” and “noise” are each examples of an information-type or aspect that may be useful to distinguish information. In certain implementations, it may be more efficient or otherwise beneficial to exclude information based on information-type from further data processing. For example, it may be beneficial to exclude “noise” information from further processing and/or to include “informative” information in further processing. As described in greater detail, the identification of data as being either “noise” or “informative” may, for example, be related to how, where, or how often such data or similar data is provided in a document and/or one or more other documents within a group of related documents.

The Internet is a worldwide system of computer networks and is a public, self-sustaining facility that is accessible to tens of millions of people worldwide. Currently, the most widely used part of the Internet appears to be the World Wide Web, often abbreviated “WWW” or simply referred to as just “the web”. The web may be considered an Internet service organizing information through the use of hypermedia. Here, for example, the HyperText Markup Language (“HTML”) may be used to specify the contents and format of a hypermedia document (e.g., a web page).

In this context, an HTML file may be a file that contains source code for a particular web page. Such HTML document may, for example, include one or more pre-defined HTML tags and their properties, and text enclosed between the tags. A web page may be an “image” or collection of images that may be displayed to a user, for example, when a particular HTML file is rendered by a browser application program or the like.

Unless specifically stated, an electronic or web document may refer to either the source code for a particular web page or the web page itself. Each web page may contain embedded references to images, audio, video, other web documents, etc. One common type of reference used to identify and locate resources on the web is a Uniform Resource Locator (URL).

In the context of the web, a user may “browse” for information by following references that may be embedded in each of the documents, for example, using hyperlinks provided via the HyperText Transfer Protocol (HTTP) or other like protocol.

Through the use of the web, individuals may have access to millions of pages of information. However, because there is so little organization to the web, at times it may be extremely difficult for users to locate the particular pages that contain the information that may be of interest to them. To address this problem, a mechanism known as a “search engine” may be employed to index a large number of web pages and provide an interface that may be used to search the indexed information, for example, by entering certain words or phases to be queried.

Indexes used by search engines may be conceptually similar to the normal indexes that may be found at the end of a book, in that both kinds of indexes may include an ordered list of information accompanied with the location of the information. An “index word set” of a document may include a set of words that may be mapped to the document. For example, an index word set of a web page is the set of words that may be mapped to the web page, in an index.

A search engine may, for example, include or otherwise employ on a “crawler” (also referred to as “crawler”, “spider”, “robot”) that may “crawl” the Internet in some manner to locate web documents. Upon locating a web document, the crawler may store the document's URL, and possibly follow any hyperlinks associated with the web document to locate other web documents. A search engine may, for example, include information extraction and/or indexing mechanisms adapted to extract and/or otherwise index certain information about the web documents that were located by the crawler. Such index information may, for example, be generated based on the contents of the HTML file associated with a web document. An indexing mechanism may store index information in a database. A search engine may provide a search tool that allows users to search the database. The search tool may include a user interface to allow users to input or otherwise specify search criteria (e.g., keywords) and receive and view search results. A search engine may present the search results in a particular order, for example, as may be indicated by a ranking scheme.

It is becoming more common for websites, which typically include a plurality of web documents, to employ a structured or semi-structured format within the web documents, for example, through the use of scripts that provide for a more uniform “look-and-feel” within a website and/or web pages. Certain websites, for example, may include more structured web pages that may be generated dynamically based on one or more templates.

Information Extraction (IE) systems may be used to gather and manipulate unstructured and/or semi-structured information on the web and populate backend databases with structured records. Such IE systems may, for example, employ rule based (e.g., heuristic based) extraction systems and/or other like automated extraction systems. In certain websites information may be stored in a database that may be accessed by a set of scripts for presentation of the information to the user.

IE systems may use extraction templates to facilitate the extraction of desired information from a group of web pages. For example, an extraction template may be based on the general layout of the group of web pages for which the corresponding extraction template is defined. One technique used for generating extraction templates is often referred to as “template induction”, which automatically constructs templates (e.g., customized procedures for information extraction) from content on the web page.

While an example may be provided of using templates to extract information from web pages, templates may be used to extract information from electronic documents having other than an HTML structure. For example, templates may be used to extract information from documents structured in accordance with XML (eXtensible Markup Language).

Web pages may include not only “informative” sections such as product information in a shopping domain, job information in a job domain, but also “other” sections such as advertisements, static content like navigation panels, copyright policy statements, etc. While each of these exemplary sections may be of some interest to certain users, it may be useful to identify different types of sections from time to time. For example, an IE system may benefit from identifying sections and/or content therein or otherwise associated therewith that may be of less importance for a search engine or other like tool to consider, and/or to include within a database.

As used herein, the term “document” is intended to broadly apply to structured documents, such as, for example, HTML documents (e.g., web pages), XML documents, documents in compliance with other markup languages, or other like documents/files.

For the purpose of the examples provided herein, it is presumed that in certain implementations information may be considered as either being “informative” or “noise”. For example, in certain implementations, advertisements and/or navigational links may be considered to be “noise” information, while a product description or job description may be considered to be “informative”.

With this in mind, some exemplary methods and systems are described below that may be used to determine or otherwise assist in determining if information may be more likely to be of an “informative” information-type or possibly more likely to be of a “noise” information-type.

The methods and systems may include or otherwise implement a template learning phase and a segmentation and noise detection phase. In the template learning phase, a template structure may be established and generalized, and feature noise confidence values may be determined. In the segmentation and noise detection phase, a document such as a web page may be compared to the template and a noise score may be determined for all or part of the information in the document. Such exemplary techniques may be employed to identify or otherwise determine common structures, information, etc., that may present in a plurality of documents and which may be more likely to be “informative” or “noise”.

A template may be expressed as a tree or other like structure. The structure of the template may be compared to the structure of the documents (or at least a part of each document), for example, in a training set of documents, one-by-one, and generalized in response to differences between the template and the document to which the template is currently being compared. Generalizing the template to match a particular document in this manner may result in a more generalized template structure. Consequently, such a generalized template may describe a common structure present in the documents from which the training set was selected.

A document object model (DOM) tree may, for example, be constructed for at least a portion of a document to facilitate comparison with the template. Generalizing the template may, for example, be achieved by generalizing the structure of the template such that the template's structure tends to match the structure of the DOM for the document. Various example “generalization operators” may be described herein, which may be added to the template to generalize it. If the structure of any particular document may be considered too dissimilar from the structure of the template, then the template may not be generalized to match the particular document (e.g., the document may be skipped).

Once the template has been created and generalized it may be used to extract information from documents outside of the training set. As an example, the template may be generalized from a training set of web pages associated with a shopping website. The learned template may be used to extract information such as product descriptions, product prices, product reviews, product images, etc.

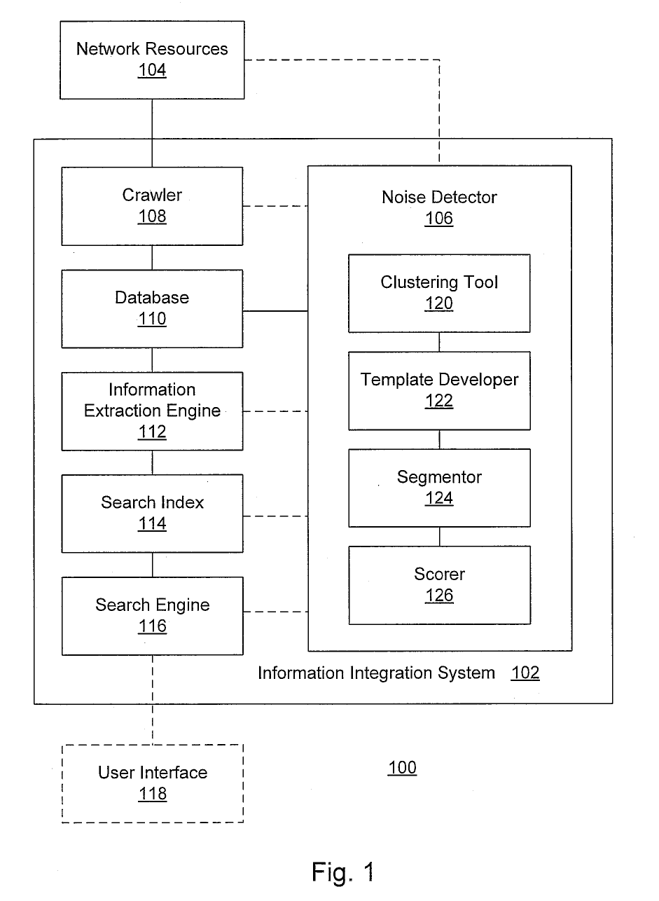

Attention is now drawn to FIG. 1, which is a block diagram illustrating an exemplary computing environment 100 having an Information Integration System (IIS) 102. The context in which such an IIS may be implemented may vary. For non-limiting examples, an IIS such as IIS 102 may be implemented for public or private search engines, job portals, shopping search sites, travel search sites, RSS (Really Simple Syndication) based applications and sites, and the like. In certain implementations, IIS 102 may be implemented in the context of a World Wide Web (WWW) search system, for purposes of an example. In certain implementations, IIS 102 may be implemented in the context of private enterprise networks (e.g., intranets), as well as the public network of networks (i.e., the Internet).

IIS 102 may include a crawler 108 that may be operatively coupled to network resources 104, which may include, for example, the Internet and the World Wide Web (WWW), one or more servers, etc. IIS 102 may include a database 110, an information extraction engine 112, a search engine 116 backed, for example, by a search index 114 and possibly associated with a user interface 118.

Crawler 108 may be adapted to locate documents such as, for example, web pages. Crawler 108 may also follow one or more hyperlinks associated with the page to locate other web pages. Upon locating a web page, crawler 108 may, for example, store the web page's URL and/or other information in database 110. Crawler 108 may, for example, store an entire web page (e.g., HTML and/or XML code) and URL in database 110.

Search engine 116 generally refers to a mechanism that may be used to index and/or otherwise search a large number of web pages, and which may be used in conjunction with a user interface 118, for example, to retrieve and present information associated with search index 114. The information associated with search index 114 may, for example, be generated by information extraction engine 112 based on extracted content of an HTML file associated with a respective web page. Information extraction engine 112 may be adapted to extract or otherwise identify specific type(s) of information and/or content in web pages, such as, for example, job titles, job locations, experience required, etc. This extracted information may be used to index web page(s) in the search index 114. One or more search indexes 114 associated with search engine 116 may include a list of information accompanied with the network resource associated with information, such as, for example, a network address and/or a link to, the web page and/or device that contains the information. In certain implementations, at least a portion of search index 116 may be included in database 110.

IIS 102 may also include an information-type detector which may identify data as being of at least one of at least two types. In this example, the information-type detector includes a noise detector 106 which may identify data as being of either a “noise” information-type or “informative” information-type.

As shown, noise detector 106 may be operatively coupled to database 110. In certain implementations, for example as indicated by dashed-lines, noise detector 106 may be operatively coupled to one or more of network resources 104, crawler 108, information extraction engine 112, search index 114, and/or search engine 116. As shown in this example, noise detector 106 may include a clustering tool 120, a template developer 122, a segmentor 124, and a scorer 126.

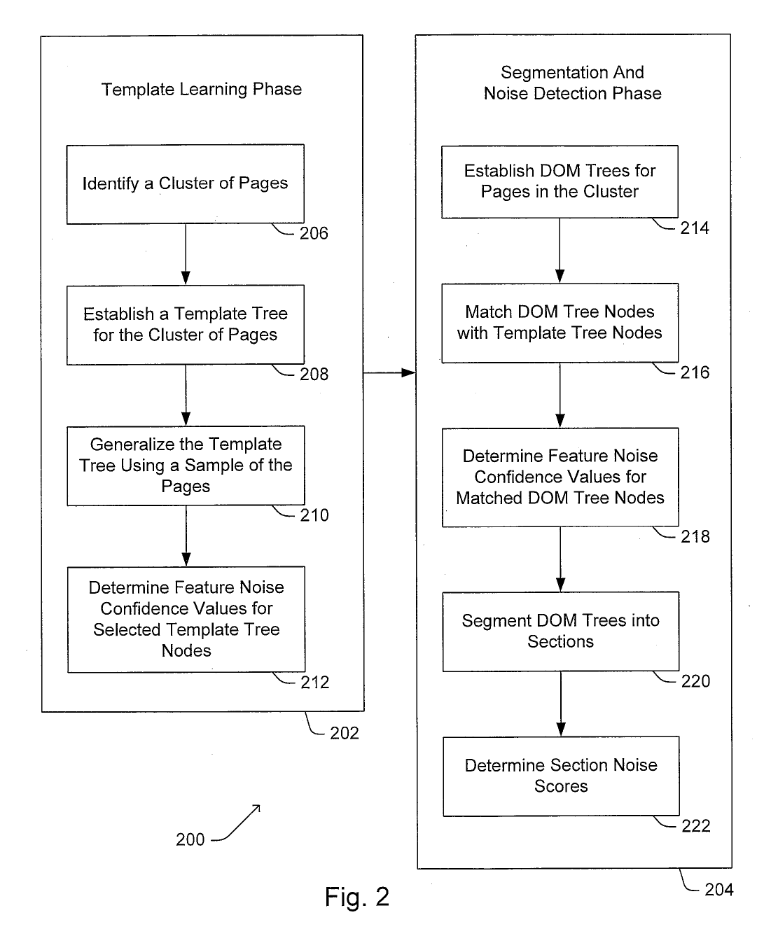

Noise detector 106 may, for example, be adapted to identify content within one or more web pages as being more likely to be of a first information-type (e.g., “noise”) and/or more likely to be of a second information type (e.g., “informative”). To identify such information-types, noise detector 106 may be adapted, for example, to perform a method that includes an initial template learning phase followed by a segmentation and noise detection phase. By way of example, all or portions of exemplary method 200 as shown in FIG. 2 may be implemented in noise detector 106. As shown, method 200 may include a template learning phase 202 and a segmentation and noise detection phase 204.

Template learning phase 202 may, at block 206, include identifying a cluster of web pages. Such functionality may, for example, be implemented at least in part in clustering tool 120 of FIG. 1. At block 208, a template tree or other like template structure may be established for the cluster of web pages. At block 210, the template tree or other like template structure may be generalized using at least a sample of web pages in the cluster. At block 212, feature noise confidence values or the like may be determined for selected template tree nodes (or other like template structure portions). All or part of the functionality of blocks 208, 210 and/or 212 may, for example, be implemented in template developer 122 of FIG. 1.

Segmentation and noise detection phase 204 may, for example, at block 214 establish DOM trees or other like structures for web pages in the cluster. At block 216, the DOM trees nodes (or other like structure portions) may be matched with template tree nodes (or other like template structure portions). At block 218, feature noise confidence values for matched DOM tree nodes (or other like structure portions) may be determined, for example, based, at least in part, on the feature noise confidence values for the template tree nodes (or other like template structure portions). At block 220, the DOM trees (or other like structure portions) may be segmented. All or part of the functionality of blocks 214, 216 and/or 218 may, for example, be implemented in segmentor 124 of FIG. 1.

Segmentation and noise detection phase 204 may, for example, at block 222 include determine section noise (or other attribute) scores for content in a web page. All or part of the functionality of block 222 may, for example, be implemented in scorer 126 of FIG. 1.

Information associated with one or more of the functions associated with noise detector 106 (FIG. 1), such as, those of template learning phase 202 and/or segmentation and noise detection phase 204, may be provided to or otherwise accessed by one or more of network resources 104, crawler 108, information extraction engine 112, search index 114, and/or search engine 116. By way of example but not limitation, section noise (or other attribute) scores from scorer 126, e.g., at block 222 (FIG. 2), may be included in database 110 and provided to information extraction engine 112 and/or search engine 116 for use in selectively determining which portion or portions of a web page may be of interest when extracting information and/or searching for certain information. In certain exemplary implementations, such section noise (or other attribute) scores from scorer 126, or other information associated with noise detector 106 may be available for use by crawler 108, network resources 104, and/or user interface 118.

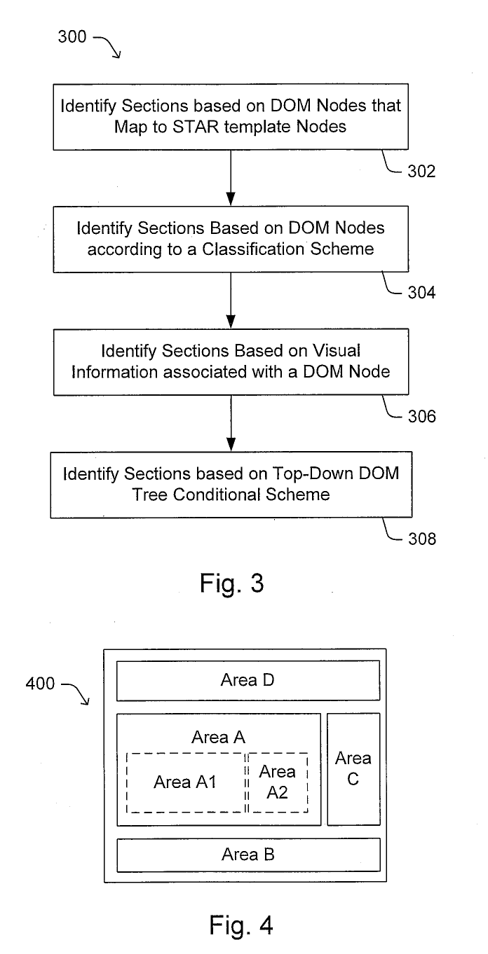

Reference is now made to FIG. 3, which is a flow diagram illustrating an exemplary method 300 that may be implemented in segmentor 124 and/or segmentation and noise detection phase 204 (e.g., at block 220). At block 302, certain sections may be identified based on mapping DOM nodes to STAR template nodes. At block 304, certain sections may be identified based on DOM nodes according to a classification scheme. At block 306, certain sections may be identified based on visual information associated with a DOM node. At block 308, certain sections may be identified based on a top-down DOM tree or other like structure conditional scheme. Some examples for the identification techniques presented in method 300 are provided in subsequent sections. While the blocks in FIG. 3 are illustrated in a linear arrangement having a particular, it should be understood that the actions of method 300 may be rearranged, combined, etc. in other implementations.

FIG. 4 is an illustrative diagram showing portions of a rendered web page 400 having visually and/or informatively distinguishable areas. For example, areas A, B, C, and D may be included in the web page 400. As shown in this example, area A may include areas A1 and A2. Any of areas A, A1, A2, B, C, and/or D may be identified as a section by segmentor 124 and/or per methods 200 or 300, for example. A score, such as, a section noise score, for any of areas A, A1, A2, B, C, and/or D may be determined by scorer 126 and/or per methods 200 or 300, for example.

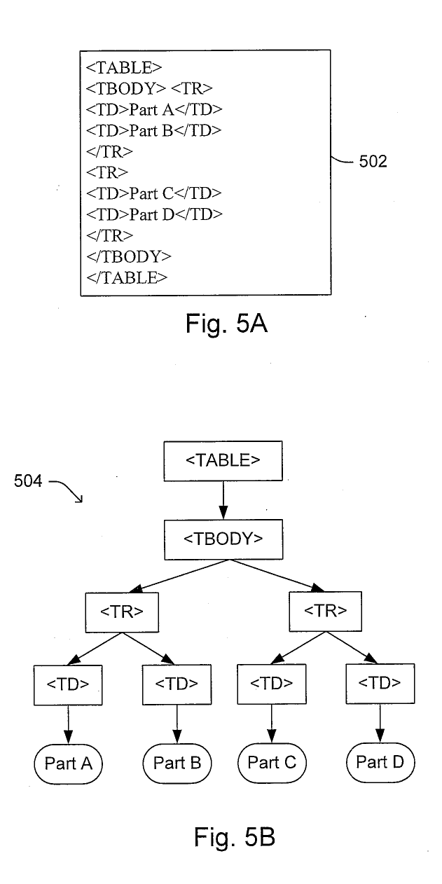

FIG. 5A is an illustrative diagram showing an exemplary document 502 having HTML information therein. Document 502 may, for example, be associated with a web page. FIG. 5B is an illustrative diagram showing an exemplary DOM tree 504 based on document 502. In DOM tree 504, for example, the <TBODY> node may have leaf nodes as the Part A-D nodes. Those skilled in the art will recognize that an exemplary template tree (e.g., as generalized for a cluster that may include document 502) may be the same or similar (at least in nodal structure) to exemplary DOM tree 504. As such, certain nodes and/or nodal structures of a DOM tree may be matched and/or mapped to nodes and/or nodal structures of a template tree. At least a portion of DOM tree 504 may also be identified as a section.

An exemplary template learning phase and segmentation and noise detection phase will now be described with reference to an exemplary website having HTML web pages.

An exemplary template learning phase may include the following actions:

I. Cluster all (or a selected portion of) pages within at least one site, for example, based on URL presentations, structural homogeneity, and/or other like aspects. In certain implementations, a website may be considered as a cluster and processed accordingly.

II. Select ‘k’ samples and create and generalize a template over ‘k’ samples. An exemplary technique for creating and generalizing a template is described in greater detail in a subsequent section. Additionally, see related U.S. patent application Ser. No. ______ (Atty. Dkt. 50269-0944 (Y02195US00)) filed on ______, titled “TECHNIQUES FOR INDUCING HIGH QUALITY STRUCTURAL TEMPLATES FOR ELECTRONIC DOCUMENTS”, the entire content of which is incorporated by reference for all purposes as if fully disclosed herein.

III. After template match and/or generalization over each document, attempt to map template node(s) to corresponding DOM node(s), as applicable. Compute or update a value for each feature, if present, for each leaf template node, for example, based on corresponding DOM node(s). Such feature values may, for example, include page support for each template node, page support for each image source feature, page support for each link feature, page support for each text feature mapping to template node, and/or the like. Additional feature values may consider other features like DOM node properties, image height, image width, font size, etc. Here, for example, the term “page support” for a feature may represent a number of pages having a specific or otherwise similar feature.

IV. After generalizing the template over ‘k’ samples, the node support and feature's noise confidence may be determined, for example, for each leaf template node. Such determination may, for example, be based, at least in part, on a node's features' statistics as determined in III (above). For example, consider a sample size of k=20. If a template node has a page support=18 and has text features, “About us” with page support=17 and “click here” with page support=1, then the node support may be 18/20 about 90%, the noise confidence of a node with text feature “About us” may be 17/18 about 94% and noise confidence of a node with text feature “click here” may be 1/18 about 6%.

V. Consider template nodes having node support greater than a particular threshold (e.g., 20%) and store the noise confidence of content (e.g., image source, link, text, and/or the like) features at such nodes if a certain threshold (e.g., 25%) is exceeded. Here, for example, such thresholds may be established or otherwise adapted to provide for a desired noise/informative (e.g., information-type identification) capability.

An exemplary segmentation and noise detection phase may include the following:

I. For each page belonging to a cluster, a DOM tree may be constructed or otherwise established. The DOM tree may be matched with template tree constructed for a cluster as a part of learning template phase and each template node mapped or otherwise matched to corresponding set of DOM nodes. Noise confidence values may be transferred to leaf DOM nodes based on the presence of a content feature. Considering above example, if a DOM node that maps to particular template node has content feature as “About us”, then a copy the noise confidence value for that content feature (here, e.g., about 94%) from the template node to the DOM node.

II. Segment the documents (e.g., web page) into one or more sections and compute a noise score for each section.

III. An exemplary web page segmentation process may, for example, include:

a) A web page may include a list of items, such as, for example, a list of products or list of navigational links, wherein each item may be represented by a set of DOM nodes. One may consider such list as a section, as all items belonging to the list may be likewise informative or noisy. By way of example, a STAR template node in a template tree may represent such a list. Hence, DOM nodes (with their subtrees) mapping to a STAR template node may be identified as a section. A DOM node may, for example, be considered to be mapped to a STAR template node, if the DOM node has mapping to a template node which is a direct or indirect child of STAR node. Note that, a STAR node may have its direct or indirect child as another STAR node, in which case, the STAR node at highest level (e.g., higher the level of a node, closer to the root node) may be used to define a section.

b) In a) (above), a set of sections may be obtained by looking at STAR nodes. For the remaining document (e.g., web page DOM nodes not mapping to such STAR node), the following actions may be taken to determine additional sections. While this example is HTML tag specific, the techniques herein may be adapted for use with other types of documents.

c) One may apply a predefined classification scheme based on an HTML tag set, such as:

1. Sectioning tags—HTML nodes like TABLE, DIV may be used to define a section.

2. Section separating tags—HTML nodes like HR, FRAMESET may be used to separate a section.

3. Rich text formatting tags—HTML nodes like B, I, STRONG may be used to enhance richness of text and may not introduce any line breaks. Thus, if a DOM node and its subtree belong to a rich text formatting tag category, then such a DOM node may be considered a “Rich Text Formatting Node”.

4. Dummy tags—HTML tags like COMMENT, SCRIPT may be considered as dummy tags, which may be ignored for segmentation purposes.

5. Other tags—tags other than above categories may be considered as other tags.

6. Visual information—visual information that may be available on each DOM node. Such visual information may, for example, be obtained by rendering the web page through a browser or the like, and/or obtained approximately.

d) The segmentation process may be top-down over a DOM tree, where a DOM node may be checked whether it is already part of a section (e.g., this could happen because of III.a. above). If a DOM node is already part of a section, then it may not need to be processed further. Otherwise, a DOM node may be further processed based on a set of conditions such as:

1. Condition 1 exists when a ratio of a DOM node's area to that of the web page's area exceeds some threshold (e.g., 15%). Here, for example, such an area of a node may be a product of a node height and a node width. The node height and width may, for example, be available as part of the visual information associated with the DOM node.

2. Condition 2 exists when one of a DOM nodes children belongs to a sectioning tag category (e.g., as presented above) and satisfies Condition 1.

3. Condition 3 exists when one of a DOM nodes children belongs to a section separating tag category (e.g., as presented above).

e) If a DOM node satisfies Condition 1 and Condition 2, then its children may be processed similarly (e.g., as mentioned in above d).

f) If a DOM node satisfies Condition 3, then all nodes belonging to the section separating tag category may be treated as section separators. Child DOM nodes between two section separators or between a first node and a first section separator or between a last section separator and a last node may be treated as separate sections. For example, consider a DOM node, Z that satisfies Condition 3, and has a children sequence of DOM nodes ABCPQCSTCXY, and wherein C belongs to a section separating tag category. Here, the resulting section set contains four sections, namely section 1, section 2, section 3, and section 4 containing, respectively, DOM nodes AB, PQ, ST, and XY.

g) Contiguous, sibling rich text formatting nodes may be considered as a section. For example, if a DOM nodes sequence is BITXSTI, where DOM nodes BITS are rich text formatting nodes, and X is not, then the resulting section set may contain three sections, namely section 5 containing DOM nodes BIT, section 6 containing DOM node X, and section 7 containing DOM nodes STI. Here, DOM nodes BIT and DOM nodes STI may be examples of contiguous, rich text formatting subtrees.

IV. Once the segmentation process is completed, each section may, for example, be classified into two classes, such as, an informative class or a noise class based, at least in part, on noise confidence values. For example, the noise confidence values of each leaf DOM node may aggregated or otherwise considered at a section level to determine a noise score for the section. The aggregation may be done in several ways including, for example, simple averaging of noise confidence values of leaf DOM nodes, a weighted averaging of noise confidence values of leaf DOM nodes (e.g., based on their size, etc.). Other section level attributes, such as, for example, a link to text ratio (e.g. link cloud), an aspect ratio of a section, section position within a page, and/or the like may be used to determine and/or alter the noise score of a section. If the noise score of a section exceeds a section noise threshold (e.g., 85%), then the section may be considered as “noise”, otherwise the section may be considered to be “informative”.

An exemplary technique for creating and generalizing a template is described below in greater detail. Such technique may be implemented, for example, in template developer 122. Those skilled in the art may recognize that other techniques may also be used to create and/or generalize a template.

An extraction template may be used to facilitate the extraction of desired information from a group of web pages. Such extraction template may, for example, be based on the general layout of the group of pages for which a corresponding extraction template may be defined. For example, an extraction template may be implemented as an HTML file that describes different portions of a group of pages, such as a product image may be to the left of the page, the price of the product may be in bold text, the product ID may be underneath the product image, etc.

Once an initial template is created, it may, for example, be generalized by comparing the template to a set of training documents. In certain implementations, the template may, for example, be compared to a DOM tree or other like structure for at least a portion of each of the training documents. Thus, herein the phrase “comparing the template to a DOM”, and other similar phrases, may refer to comparing the structure of the template to the structure of a DOM tree or other like structure that models at least a portion of a document. An initial template may, for example, be created based on a sample HTML. Thus, for example, if a goal is to build a template that may be suitable for a shopping website, a relevant portion of a shopping page may be used as a sample HTML input.

In certain implementations, a suffix tree may be created from a sample HTML. A suffix tree may be a data-structure that represents suffixes starting from all positions in a sequence, S. The suffix-tree may, for example, be used to identify continuous-repeating patterns. However, a structure other than a suffix tree may be used to identify patterns.

The suffix tree may be analyzed to generate a regular expression (“Regex”) HTML. An initial template may be generated from the Regex HTML. The template may include HTML nodes and nodes corresponding to defined operators. An example of an HTML node may be an HTML tag such as, title, table, tr, td, h1, h2, p, etc. By way of example but not limitation, defined operators may include STAR, HOOK, and OR. A STAR operator may indicate that any subtrees that stem from children of the STAR operator may be allowed to occur one or more times in the DOM tree. A HOOK operator may indicate that the underlying subtrees may be optional. In certain implementations, a HOOK operator may be allowed to have only one underlying subtree. In other words, in certain implementations a HOOK operator may only a single child. An OR operator in the template may indicate that only one of the subtrees underlying the OR operator may be allowed to occur at the corresponding position in the DOM tree.

It may be not required that the template contain HTML nodes. In one implementation, the template includes XML nodes and nodes corresponding to defined operators.

A template may be generalized such that its structure matches that of a common structure of the training documents. To generalize the template to match a particular DOM structure, first the template may be compared to the DOM structure to determine certain differences. Differences may be resolved by adding one or more operators to the template, which results in matching the template to the current DOM structure by making the template more general. The changes to the template may be made in such a way that the template will still match with DOM structures for which the template was previously generalized to match.

The following section describes initial creation of an exemplary template. A training document (e.g., HTML page) may be encoded into a character sequence, S=s₁s₂ . . . sₙ. In an implementation, all text outside of HTML tags may be encapsulated into a special <TEXT> token. For example, the text that describes an item for sale on a shopping site web page would be represented as a TEXT token. The HTML tags themselves may be also represented as tokens. For example, there may be a TABLE token, a TABLE ROW token, etc. Then, each token may be mapped to a character sᵢ (or a unique group of characters sᵢ . . . sₖ, if required).

A suffix-tree may be built on the character sequence “S”. The suffix tree may reflect patterns in the character sequence. The patterns may be identified by analyzing sub-strings within the character sequence. As an example of continuous-repeating patterns, “ab” (starting at position 1 and position 3) in the character sequence and “ba” (starting at position 2 and position 4) may be identified as repeating patterns. The pattern “abc” starting at position 5 may be an example of a pattern that may be not repeated.

As such, valid patterns may be identified. For example, certain tags may have an “open” tag followed, at some point, by a “close” tag. As a particular example, a “bold open tag” may precede a “bold close tag”. Such a sequence of tags may be used to identify patterns that may be valid and invalid and more prominent in the neighborhood.

A regular expression, “R”, may be constructed, for example, by replacing multiple occurrences in the suffix tree with a single occurrence. As an example, if a suffix tree has multiple occurrences of “ab”, which may be replaced by a single occurrence “ab*”, where the “*” indicates that pattern occurs more than once in the suffix tree. For example, from the character sequence S, a regular expression R may be constructed by replacing multiple occurrences of a pattern in S by an equivalent regular expression. In one example, “ababab” in S may be replaced by “(ab)*”. Thus, from S=“abababc”, generate R=“(ab)*c”. The suffix tree may be used to find these multiple occurrences, but does not store the regular expression.

Another string, S′ may be formed, for example, by neglecting all of the patterns in R having a “*” character, in an implementation and actions may be repeated on S′ to find more complex and nested patterns until no more patterns may be available. At the end of this stage, a regular expression, R, may be available with multiple occurrences replaced by a starred-single occurrence. All of the characters in R may then be replaced by their equivalent HTML tags. A regular-expression tree may be built on R, such that any nested HTML tag may be represented as a hierarchy. An example regular-expression tree for the following expression: <B>(<A><TEXT></A><TEXT>)*</B>

In certain implementations, a full regular expression tree may serve as the basis for an initial template to be used to compare with documents in a training set. However, as described below, the initial template may be generalized prior to comparing the template to training documents.

After initial creation, the template may have subtrees that may be approximately, although not exactly, the same. Note that there may be some similarity in the subtrees. As the previous section describes, subtrees that may be identical may be merged and the “STAR” operator may be used to indicate that more than one subtree may be represented. The following generalization process may be used to merge subtrees that may be substantially similar, but not identical.

In one implementation, similar subtrees in the template may be merged and generalized using a similarity function on the paths of the template. In an implementation, this generalization process may include two phases: i) identification of approximation locations and boundary; and ii) approximation methodology.

Initially, a set of candidate nodes in the template may be identified for a determination as to whether a subtree of a particular candidate node has a similar subtree. For example, all STAR nodes may be considered candidate nodes. The subtree associated with a particular STAR node may be compared with the sibling subtrees of the same STAR nodes to look for similar subtrees. The candidate nodes do not have to be STAR nodes, but could be any set of nodes. The candidate nodes may be the same type of nodes. In the following description, the template node whose subtree may be under consideration for similar subtrees may be referred to as “fpa_node.”

A modified similarity function may be used to find the boundary of match, in an implementation. Initially, all “paths” within the selected template node, fpa_node, may be determined. A path from an arbitrary node “p” may be defined as a series of HTML tags starting from node p to one of the leaf nodes under node p.

First, all “paths” within the selected template node fpa_node may be determined. These will be referred to as “fpa_node paths”. A path from a node p may be defined as a series of HTML tags starting from p to one of the leaf nodes under p, in an implementation. For example, fpa_node paths may include tr/td/B/TEXT, tr/td/A/TEXT, tr/td/IMG, and tr/td/FONT/TEXT.

Next, paths may be computed for the siblings of fpa_node. These will be referred to as “sibling paths”. The computed sibling paths may be compared to the fpa_node paths to look for path matches. A path match may occur, for example, when an fpa_node path matches a sibling path.

A “current sibling” refers to the sibling whose paths may be currently being compared to the fpa_node paths. Based on the number of matching paths, a similarity score may be computed, in an implementation. The numerator may be the number of fpa_node paths that have a match in the sibling paths. The denominator may be the number of unique fpa_node paths and all sibling paths up until the current sibling. For example, a ratio of matching paths from fpa_node paths to first and second sibling nodes may be 2/5 and 4/5, respectively. Such, ratios may be referred to as “similarity scores”.

If the current similarity score exceeds a specified threshold, that sibling node may be considered to be a “boundary”. However, if current similarity score does not exceed the specified threshold, then the paths from the next sibling node may be combined and a similarity score may be computed. The paths of such sibling nodes may be combined and if the resulting similarity score exceeds the specified threshold, the siblings may be considered to be candidates for merging (in other words, a boundary may be found). In certain implementations, the range of the siblings up until a boundary node may be considered for merging.

In certain implementations, if there is a HOOK node present in a path under the fpa_node, then the HOOK node may only be considered if there is a path under a sibling set that matches this “optional path”.

Paths containing OR may be weighed against each other such that the presence of any one of them may be treated as a presence of the entire set. For example, if there are three children to an OR node, then there will be at least three paths through this OR node—one through each of these three children. Note that there may be more than three paths if these children have a subtree below them; however, to facilitate explanation this example assumes there are only three paths. Because an OR node indicates that only one of each of the three paths may be allowed, then if any one of this set of three paths may be present in the sibling's paths, the entire set may be treated as present, in an implementation. Thus, a count of one may be added to the numerator and denominator of the ratio fraction, if at least one of the paths under the OR node matches. Otherwise, a count of one may be added only to the denominator.

Once merging happens successfully, the process may be repeated for remaining sibling subtrees. The merging may be called “successful”, if the cost of modifying template may be less than a cost threshold, otherwise merging may be called “failed”. The merging may be performed by generalizing the subtree under the fpa_node such that it matches with the subtrees associated with the siblings. After the merging, the subtrees under siblings may be considered for merging with the subtree under the fpa_node.

Once a boundary has been identified, the template may be generalized based on the segments. In certain implementations, generalizing the template based on the segments may, for example, be performed to match a training document or partial document subtree. In the present example of generalizing the initial template, a portion of the template, referred to herein as a template component, may be matched to other portions of the template, referred to herein as template segments or subtrees. That is, template subtrees corresponding to segments in the template may be matched with the template component to generalize the template component. For example, a template component may be generalized to match a first template segment, which results in a modified template component that may be generalized to match a second template segment, which results in a further generalized template component. By generalizing the template component (or portion thereof) to match a template segment it is meant that a comparison of the generalized template component with the template segment may not have any mismatches when applying a set of rules that determine whether the generalized template component matches the template segment.

Thus, as described above, an exemplary template may include either HTML nodes or nodes corresponding to one of the defined operators (e.g., STAR, HOOK, OR). The STAR operator may be represented by ‘*’, and the HOOK operator may be represented by ‘?’. Given a new document for learning, the DOM of the document may be matched with the template in a depth first fashion. By depth first, it is meant that processing may proceed from a parent node to the leftmost child node of the parent. After processing all of the leftmost child's subtrees in a depth first fashion, the child to the right of the leftmost child may be processed. When there is a mismatch between tags, a mismatch routine may be invoked in order to determine whether to match the template to the DOM.

Comparing the template to the DOM may depend on the type of operator that may be the parent of a subtree in the template. For example, if a STAR operator may be encountered in the template, then the subtree of the STAR operator may be compared to the corresponding portion of the DOM in accordance with STAR operator processing, as described below. Subtrees having a HOOK operator or an OR operator as a parent node may be processed in accordance with HOOK operator processing and OR operator processing respectively.

Processing of a subtree under a STAR node in the template may occur by traversing the nodes in the subtree in a depth first fashion, comparing the template nodes with the DOM nodes. If all children match at least once, then the STAR subtree matches the corresponding subtree in the DOM. If a subtree contains a STAR node, the routine that processes STAR subtrees may be recursively invoked. A routine may be invoked to evaluate a HOOK path in the subtree, because the HOOK operator may indicate that the subtree below the HOOK may be optional, and the DOM may be not required to have that subtree in order to match. After processing the leftmost subtree in the DOM, the rightmost subtree may be compared to the template subtree.

The subtree under a STAR node may be present in the DOM more than one time. Processing may depend on whether all of the children of the STAR node have matched the DOM at least once. If there is a mismatch between a STAR subtree and the subtree in the DOM under consideration, a determination may be made as whether the STAR subtree has matched in the DOM at least once. If the STAR subtree has not matched even once, then the STAR subtree may be said to have failed the match, and a mismatch routine may be used. The mismatch routine may, for example, be informed that the STAR subtree failed to match at all.

Note that processing the STAR subtree may include performing a number of cycles. For example, a STAR subtree may be compared to a plurality of different subtrees in the DOM.

If a template node is a HOOK, then the DOM node may, for example, be matched with children of the HOOK node. In certain implementations, a HOOK node may at least one child and possibly multiple grandchildren. In other implementations, a HOOK node may be limited to only one child. If the subtree in the DOM matches the subtree under the HOOK node in the template, the matching may continue with the next template and DOM nodes. If a subtree under a HOOK node matches only partially with the subtree under the corresponding DOM node, the extent of match may be recorded. The extent of the match may be based on the number of nodes in the subtree that do match and the number that do not match. The extent of a mismatch may, for example, be expressed as a ratio, percentage, etc., which reflects that nodes matches and mismatches. Different nodes may have different weights when computing the extent of match. For example, nodes may be weighted based on their level. In one implementation, nodes at a higher logical level in the tree may be assigned a greater weight.

When a subtree in the DOM fails to match a subtree in the template it may be matched with subtrees that may be rooted at template nodes that may be siblings of the template node that was the root of the mismatch. Such process may continue on until the root template node is not a HOOK node. If there are multiple HOOK nodes, then the subtrees of each of the HOOK nodes may be matched with a mismatched subtree. If any of these hypothetical template subtrees is an exact match with a mismatched subtree, then the mismatched subtree may be considered to have been matched with the template. However, if none of these hypothetical template subtrees match the mismatched subtree, then one of the template subtrees may be selected to be modified such that it will match the mismatched subtree. In certain implementations, the template subtree that comes closest to matching the mismatched subtree may be selected for modification.

In certain implementations, a cost of modifying a template may be computed to determine how to modify the template. Determining how to modify the template may, for example, include determining a location, types of nodes, etc. A decision may also be made as to whether or not to modify the template, based on a cost.

If a template has an OR node and subtrees (e.g., multiple children), then a subtree in the DOM 804 may be matched with each subtree of the OR node and an extent of match may be recorded for each comparison. If the DOM subtree had an exact match in the template, then there may be no need for a modification. In other situations, a decision may be made to modify a subtree such that it matches the DOM C subtree. In certain situations, it may be possible to add a new subtree to the template to match the DOM subtree. Adding a subtree to the template may, for example, be performed if the cost of modifying an existing subtree in the template may be less than a specified threshold.

When comparing a template node to DOM node, if the names (e.g., tag names) do not match, then a mismatch routine may be called with an indication of the mismatched template node and DOM nodes. It may be possible that a node exists in a template that has no corresponding node in a DOM or vice versa. For this type of mismatch, a mismatch routine may be called with an additional indication that one of the two nodes (in the DOM or template) may be absent. Note when processing an OR subtree, there is no requirement that an OR operator be added. For example, in certain situations, a HOOK operator may be added to an OR subtree 813 to resolve a mismatch between the template and the DOM.

When a mismatch routine is used (e.g., called) due to a mismatch between the template and the DOM, a determination may be made as to whether to resolve the mismatch by generalizing the template. If the template is generalized, the mismatch may be resolved by adding an appropriate STAR, HOOK, or OR operator, thereby generalizing the template. A mismatch may, for example, occur in two cases: (i) when the structure of the template and DOM have corresponding nodes, but the nodes not match with each other, and (ii) when the structure may be such that a node may be absent in either the template or the DOM.

When a DOM node is to be added into the template, the DOM subtree may be first normalized into a regular expression by finding repeated patterns in that subtree. This may be similar to how the regex may be learned for the initial template. Thus, in certain implementations, “adding a DOM node to the template” may be accomplished by “adding a regex tree corresponding to the DOM node to the template”.

If there may be a tag mismatch, an attempt may be made to add a STAR node to the template. If STAR addition fails, an attempt may be made to add a HOOK node to the template. If the attempt to add a HOOK node fails, then an OR node may be added to the template. The details of each of the three operations may be explained below.

The order in which the addition of operators to the template may be attempted may be vary. In one implementation, the choice of which operator to add to the template may also be determined based on the extent of change (e.g., cost) that adding operators would induce on the template structure.

When the template may be modified (or proposed to be modified), the template may be said to incur a cost of generalization. This cost may, for example, be the cost of modifying the template to match the current document completely. A low cost may imply that the current document may be similar to the other documents in the training set used to build the template. On the other hand, a high cost may imply relatively large differences and possibly that the current document may be heterogeneous with respect to the rest of the training documents. In an implementation, a cost threshold may be specified for the cost wherein the template may be not modified to match the current document if the cost would exceed the cost threshold. Thus, documents that may be too dissimilar from the rest of the training documents may, in effect, be removed from the training set.

The following are example factors that may, for example, be used to compute the cost. It may be not required that all of the factors be used. Each factor may be weighed differently.

1) The size of the changed subtree (number of nodes in the subtree), S. The larger the size of the subtree added/modified, the higher may be the cost of change.

2) The height (depth) of the subtree added/modified, H. In principle, on a modified subtree, the nodes added at the top of the subtree have more importance and hence incur higher cost than those at the bottom. It means that a cost of addition of a subtree of size S will be larger if it may be a shallow tree (the subtree has lower H).

3) The level in the template which this change occurred, L, computed from the top of the template. The cost decreases exponentially with increasing L. This means that the changes towards the top of the tree incur more cost than those towards the bottom of the tree.

4) The operator added. In one implementation, the STAR operator does not add any cost, since it generalizes the repetition count. In one implementation, the OR operator induces cost based on whether it may be added as a new node to the template or another disjunction may be added to an existing OR node. In one implementation, the HOOK operator cost depends on whether an existing structure in the template may be made optional or a new optional subtree may be added to the template.

A particular example of the cost function may be Cost=S×10^{1-[(L+H/2)D]}, where D may be the overall depth (height) of the template and used to normalize the numerator L+H/2. There may be many other such functions.

The cost of change may be compared against the sizes of the original template and the current DOM. The size of the current template may be computed similar to the one used to compute the cost of change—i.e., every node may be weighed proportional to its height H in the template. The current page may be said to make a significant change to the template if cost of change induced by the current page may be more than a pre-determined fraction (say 30%) of the template and DOM sizes. The template and DOM size may be calculated in many other ways—by simply counting the number of nodes in the template/DOM to weighing them differently by their depth in the tree, relative importance, etc.

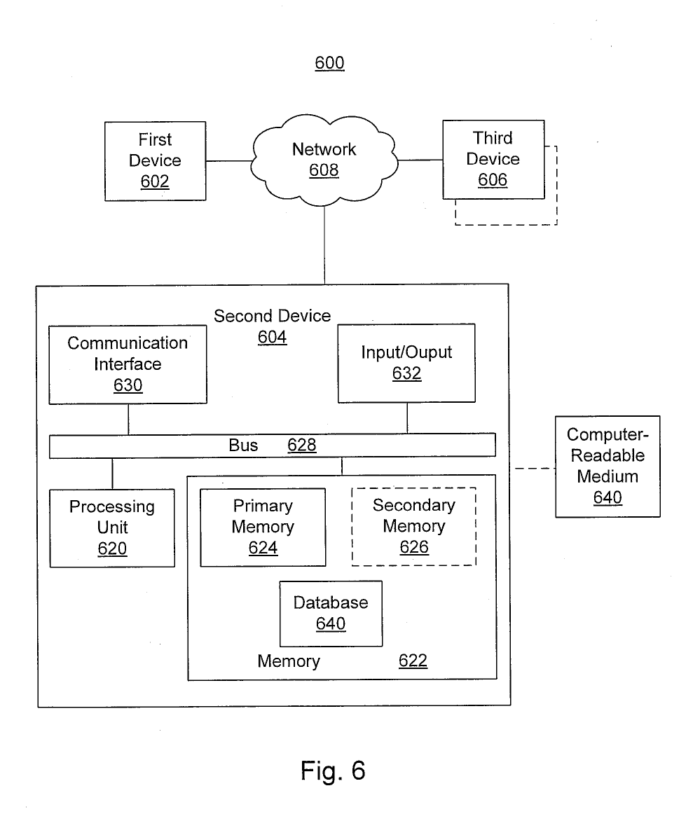

FIG. 6 is a block diagram illustrating an exemplary embodiment of a computing environment system 600 which may be operatively associated with computing environment 100 of FIG. 1, for example.

Computing environment system 600 may include, for example, a first device 602, a second device 604 and a third device 606, which may be operatively coupled together through a network 608.

First device 602, second device 604 and third device 606, as shown in FIG. 6, are each representative of any device, appliance or machine that may be configurable to exchange data over network 608 and host or otherwise provide one or more replicated databases. By way of example but not limitation, any of first device 602, second device 604, or third device 606 may include: one or more computing devices or platforms, such as, e.g., a desktop computer, a laptop computer, a workstation, a server device, storage units, or the like.

Network 608, as shown in FIG. 6, is representative of one or more communication links, processes, and/or resources configurable to support the exchange of data between at least two of first device 602, second device 604 and third device 606. By way of example but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 606, there may be additional like devices operatively coupled to network 608.

It is recognized that all or part of the various devices and networks shown in system 600, and the processes and methods as further described herein, may be implemented using or otherwise include hardware, firmware, software, or any combination thereof.

Thus, by way of example but not limitation, second device 604 may include at least one processing unit 620 that is operatively coupled to a memory 622 through a bus 628.

Processing unit 620 is representative of one or more circuits configurable to perform at least a portion of a data computing procedure or process. By way of example but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 640. Computer-readable medium 640 may include, for example, any medium that can carry and/or make accessible data, code and/or instructions for one or more of the devices in system 600.

Additionally, as illustrated in FIG. 6, memory 622 may include a data associated with a database 640. Such data may, for example, be stored in primary memory 624 and/or secondary memory 626.

Second device 604 may include, for example, a communication interface 630 that provides for or otherwise supports the operative coupling of second device 604 to at least network 608. By way of example but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 632 may include an operatively adapted display, speaker, keyboard, mouse, trackball, touch screen, data port, etc.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
determining at least one feature information-type confidence value associated with a template structure node; and
for at least one document, determining at least one section information-type score based, at least in part, on said at least one feature information-type confidence value.

2. The method as recited in claim 1, wherein said information-type is selected from a group of information-types comprising noise information and informative information.

3. The method as recited in claim 1, further comprising:
creating and generalizing a template based, at least in part, on at least one training document, said template having a template structure and comprising at least said template structure node.

4. The method as recited in claim 3, further comprising:
establishing said template for a plurality of documents, said plurality of documents comprising said at least one training document and said at least one document.

5. The method as recited in claim 4, further comprising:
identifying said plurality of documents, said plurality of documents comprising a cluster of documents.

6. The method as recited in claim 5, wherein cluster of documents comprises a plurality of web pages associated with at least one website.

7. The method as recited in claim 1, further comprising:
for said at least one document, accessing a document structure comprising at least one document structure node;
matching said at least one document structure node with at least said template structure node; and
determining an information-type confidence value for the matched document structure node based, at least in part, on said at least one feature information-type confidence value associated with said template structure node.

8. The method as recited in claim 7, further comprising:
establishing said document structure.

9. The method as recited in claim 7, wherein said document structure is associated with a document object model (DOM).

10. The method as recited in claim 7, wherein said document structure comprises a tree structure.

11. The method as recited in claim 1, further comprising:
for said at least one document, accessing a document structure comprising at least one document structure node;
identifying at least one segment within said document structure, said at least on segment being associated with said at least one section information-type score.

12. The method as recited in claim 11, wherein said segment comprises a plurality of document structure nodes, and wherein determining said at least one section information-type score is determined based, at least in part, on a plurality of feature information-type confidence values associated with said plurality of document structure nodes.

13. The method as recited in claim 11, wherein identifying said at least one segment within said document structure further comprises identifying said at least one segment based, at least in part, on at least one of:
a STAR template node;
a classification scheme associated with a hypertext markup language;
at least one renderable visual aspect of the information associated with said least one document structure node; and
a top-down document structure conditional scheme.

14. A system comprising:
a detector adapted to determine at least one feature information-type confidence value associated with a template structure node, and for at least one document, determine at least one section information-type score based, at least in part, on said at least one feature information-type confidence value.

15. The system as recited in claim 14, wherein said information-type is selected from a group of information-types comprising noise information and informative information.

16. The system as recited in claim 14, wherein said detector is further adapted to identify a plurality of documents, said plurality of documents said plurality of documents comprising at least one training document and said at least one document, establish a template for said plurality of documents, and generalize said template based, at least in part, on said at least one training document, said template having a template structure and comprising at least said template structure node.

17. The system as recited in claim 14, wherein said detector is further adapted to, for said at least one document, access a document structure comprising at least one document structure node, match said at least one document structure node with at least said template structure node, and determine an information-type confidence value for the matched document structure node based, at least in part, on said at least one feature information-type confidence value associated with said template structure node.

18. The system as recited in claim 14, wherein said detector is further adapted to, for said at least one document, access a document structure comprising at least one document structure node, and identify at least one segment within said document structure, said at least on segment being associated with said at least one section information-type score.

19. The system as recited in claim 18, wherein said segment comprises a plurality of document structure nodes, and wherein determining said at least one section information-type score is determined based, at least in part, on a plurality of feature information-type confidence values associated with said plurality of document structure nodes.

20. The system as recited in claim 18, wherein said detector is further adapted to identify said at least one segment based, at least in part, on at least one of a STAR template node, a classification scheme associated with a hypertext markup language, at least one renderable visual aspect of the information associated with said least one document structure node, and a top-down document structure conditional scheme.
